(19) United States
(12) Patent Application Publication
(10) Pub. No.: US 2026/0239423 A1
(43) Pub. Date: Aug. 13, 2026

(54) CHANNEL OCCUPANCY TIME SHARING

(71) Applicant: LENOVO (SINGAPORE) PTE. LTD., Singapore (SG)

(72) Inventors: Karthikeyan Ganesan, Nauheim (DE); Alexander Golitschek Edler von Elbwart, Darmstadt (DE); Ravi Kuchibhotla, Chicago, IL (US)

(73) Assignee: Lenovo (Singapore) Pte. Limited, Singapore (SG)

(21) Appl. No.: 19/160,410

(22) PCT Filed: Mar. 1, 2024
(86) PCT No.: PCT/IB2024/052019

§ 371 Date: Aug. 27, 2025

Related U.S. Application Data
(60) Provisional application No. 63/487,878, filed on Mar. 1, 2023.

(51) Int. Cl. H04W 74/0816; H04W 74/04

(52) U.S. Cl. CPC H04W 74/0816; H04W 74/04

(57) ABSTRACT

Various aspects of the present disclosure relate to methods, apparatuses, and systems that support channel occupancy time (COT) sharing. For instance, implementations provide techniques that support COT sharing. Implementations, for example, provide ways in which Layer 1 (L1) identifier (IDs) can be implicitly provided by a COT initiator to select COT candidates. For instance, in implementations L1 IDs of COT candidates are not transmitted explicitly in SCIs.

### RELATED APPLICATION

This application claims priority to U.S. Provisional Application Ser. No. 63/487,878 filed 1 Mar. 2023 entitled “CHANNEL OCCUPANCY TIME SHARING,” the disclosure of which is incorporated by reference herein in its entirety.

### TECHNICAL FIELD

The present disclosure relates to wireless communications, and more specifically to channel occupancy time (COT) sharing.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Some wireless communications systems provide ways for sharing COT. However, current systems may experience difficulties in sharing COT information in certain scenarios.

### SUMMARY

The present disclosure relates to methods, apparatuses, and systems that support COT sharing. For instance, implementations provide techniques that support COT sharing. Implementations, for example, provide ways in which Layer 1 (L1) identifier (IDs) can be implicitly provided by a COT initiator to select COT candidates. For instance, in implementations L1 IDs of COT candidates are not transmitted explicitly in SCIs, which can thus conserve a size of sidelink control information (SCI).

Thus, by utilizing the described techniques, wireless resources (e.g., wireless resources in unlicensed spectrum) can be more efficiently used and wireless communication overhead (e.g., for SCI) can be conserved.

Some implementations of the method and apparatuses described herein may further include a UE for wireless communication to perform a listen before talk procedure in an unlicensed spectrum to initiate a channel occupancy duration; select one or more COT candidate UE using one or more Layer 1 (L1) identifiers (IDs) provided by a COT initiator using one or more of an explicit indication or an implicit indication; and transmit, based on the one or more of the explicit indication or the implicit indication, a UE-to-UE COT sharing indicator to one or more COT candidate UE for sharing a remaining channel occupancy duration.

In some implementations of the method and apparatuses for a UE described herein, the listen before talk procedure includes a category 4 (Cat 4) listen before talk procedure; the at least one processor is configured to cause the UE to select the one or more COT candidate UE implicitly and based on the one or more L1 IDs transmitted by the COT initiator; the at least one processor is configured to cause the UE to select the one or more COT candidate UE implicitly and based on the one or more L1 IDs transmitted by the COT initiator from one or more of a first physical sidelink control channel (PSCCH) slot or a first physical sidelink shared channel (PSSCH) slot of the channel occupancy until one or more of a PSCCH slot or a PSSCH slot in which the COT sharing indicator is transmitted within the channel occupancy duration; the at least one processor is configured to cause the UE to receive an explicit indication of the one or more L1 IDs; the explicit indication includes sidelink control information (SCI); the SCI includes information restricting a number of the one or more COT candidate UE.

Some implementations of the method and apparatuses described herein may further include a processor for wireless communication to perform a listen before talk procedure in an unlicensed spectrum to initiate a channel occupancy duration; select one or more COT candidate user equipment (UE) using one or more Layer 1 (L1) identifiers (IDs) provided by a COT initiator using one or more of an explicit indication or an implicit indication; and transmit, based on the one or more of the explicit indication or the implicit indication, a UE-to-UE COT sharing indicator to one or more COT candidate UE for sharing a remaining channel occupancy duration.

In some implementations of the method and apparatuses for a processor described herein, the listen before talk procedure includes a category 4 (Cat 4) listen before talk procedure; the at least one controller is configured to cause the processor to select the one or more COT candidate UE implicitly and based on the one or more L1 IDs transmitted by the COT initiator; the at least one controller is configured to cause the processor to select the one or more COT candidate UE implicitly and based on the one or more L1 IDs transmitted by the COT initiator from one or more of a first physical sidelink control channel (PSCCH) slot or a first physical sidelink shared channel (PSSCH) slot of the channel occupancy until one or more of a PSCCH slot or a PSSCH slot in which the COT sharing indicator is transmitted within the channel occupancy duration; the at least one controller is configured to cause the processor to receive an explicit indication of the one or more L1 IDs; the explicit indication includes sidelink control information (SCI); the SCI includes information restricting a number of the one or more COT candidate UE.

Some implementations of the method and apparatuses described herein may further include a method performed by a UE, the method including performing a listen before talk procedure in an unlicensed spectrum to initiate a channel occupancy duration; selecting one or more COT candidate UE using one or more Layer 1 (L1) identifiers (IDs) provided by a COT initiator using one or more of an explicit indication or an implicit indication; and transmitting, based on the one or more of the explicit indication or the implicit indication, a UE-to-UE COT sharing indicator to one or more COT candidate UE for sharing a remaining channel occupancy duration.

In some implementations of the method and apparatuses described herein, the method further comprising where the listen before talk procedure includes a category 4 (Cat 4) listen before talk procedure; selecting the one or more COT candidate UE implicitly and based on the one or more L1 IDs transmitted by the COT initiator; selecting the one or more COT candidate UE implicitly and based on the one or more L1 IDs transmitted by the COT initiator from one or more of a first physical sidelink control channel (PSCCH) slot or a first physical sidelink shared channel (PSSCH) slot of the channel occupancy until one or more of a PSCCH slot or a PSSCH slot in which the COT sharing indicator is transmitted within the channel occupancy duration; further including receiving an explicit indication of the one or more L1 IDs; the explicit indication includes sidelink control information (SCI).

### BRIEF DESCRIPTION OF THE DRAWINGS

FIG. 1 illustrates an example of a wireless communications system that supports COT sharing in accordance with aspects of the present disclosure.

FIG. 2 illustrates an example of a sidelink slot that supports COT sharing in accordance with aspects of the present disclosure.

FIG. 3 illustrates a scenario that supports COT sharing in accordance with aspects of the present disclosure.

FIG. 4 illustrates a scenario that supports COT sharing in accordance with aspects of the present disclosure.

FIG. 5 illustrates an example of a block diagram of devices that support COT sharing in accordance with aspects of the present disclosure.

FIG. 6 illustrates a flowchart of a method that supports COT sharing in accordance with aspects of the present disclosure.

### DETAILED DESCRIPTION

In wireless communications systems, sidelink unlicensed operation is gaining momentum. For instance, COT sharing has been discussed such as for gNB initiated COT sharing and UE initiated COT sharing. A group common downlink control information (DCI) format 2_0, for instance, can indicate a plurality of COT sharing indicators initiated by a gNB to each of a plurality of cells and a UE initiated COT sharing indicator shared to a gNB using a field in configured grant uplink control information (CG-UCI). A COT sharing indicator, however, is to be defined in NR sidelink for unlicensed spectrum to enable feedback from Rx UEs, PSSCH transmission from Rx UEs, etc., in a remaining channel occupancy duration. UE to UE COT sharing procedures considering Tx UE connection with multiple Rx UEs and/or destination IDs are also to be implemented.

In addition to the source and destination IDs carried in second SCI from a COT initiating UE, other identifiers (ID(s)) of unicast, groupcast, and/or broadcast session(s) to which the COT initiating UE also belongs can also be indicated as part of COT sharing information. This information, for instance, can support scenarios for a COT responding/candidate UE to transmit PSSCH/PSCCH to a destination ID other than the source ID of the COT initiating transmission, where the destination ID of the responding UE PSSCH/PSCCH transmission(s) can be different from the source/destination IDs of COT initiating UE's PSSCH/PSCCH transmission when sharing the COT information.

Accordingly, this disclosure provides for techniques that support COT sharing. For instance, implementations provide ways in which Layer 1 (L1) identifier (IDs) can be implicitly provided by a COT initiator to select COT candidates. For instance, in implementations L1 IDs of COT candidates are not transmitted explicitly in SCIs, which can thus conserve a size of the SCI.

Thus, by utilizing the described techniques, wireless resources (e.g., wireless resources in unlicensed spectrum) can be more efficiently used and wireless communication overhead (e.g., for SCI) can be conserved.

Aspects of the present disclosure are described in the context of a wireless communications system. Aspects of the present disclosure are further illustrated and described with reference to device diagrams and flowcharts.

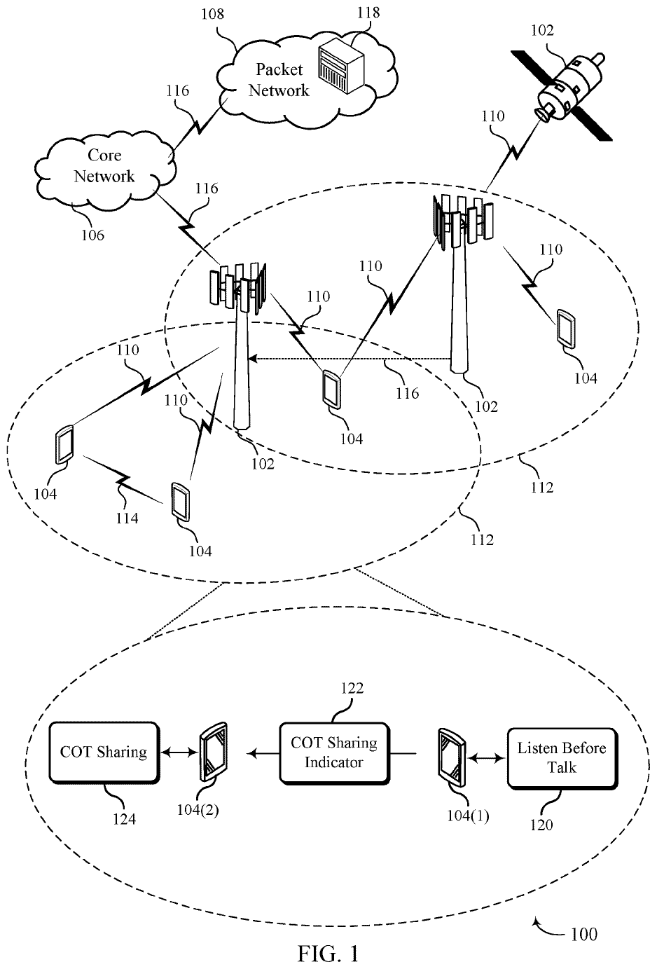

FIG. 1 illustrates an example of a wireless communications system 100 that supports COT sharing in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a RAN, a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, V2X deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-real time (RT) RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., radio resource control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, MAC layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N2, or another network interface). The packet data network 108 may include an application server 118. In some implementations, one or more UEs 104 may communicate with the application server 118. A UE 104 may establish a session (e.g., a PDU session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (e.g., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency-division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHZ-24.25 GHz), FR4 (52.6 GHz-114.25 GHz), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations for COT sharing, a UE 104(1) (e.g., a “COT initiator”) performs a listen before talk procedure 120 in a portion of unlicensed spectrum. The listen before talk procedure 120, for instance, represents a clear channel assessment (CCA) performed in a portion of unlicensed frequency. Based on success of the listen before talk procedure 120 (e.g., the UE 104(1) does not detect the presence of other signals in a channel), the UE 104(1) generates a COT sharing indicator 122 and transmits the COT sharing indicator 122 to a UE 104(2). The COT sharing indicator 122, for instance, includes L1 IDs for COT sharing candidates, e.g., other UEs that can utilize available COT. The COT sharing indicator 122 can be transmitted in various ways, such as part of SCI. Different examples and implementations of the COT sharing indicator 122 are described throughout this disclosure. The UE 104(2) receives the COT sharing indicator 122 and can perform COT sharing 124 using unlicensed spectrum resources, such as identified in the COT sharing indicator 122. The UE 104(2), for instance, can perform sidelink transmissions as part of the COT sharing 124.

Sidelink control information (SCI) format 2-A is used for the decoding of PSSCH, with HARQ operation when Hybrid Automatic Repeat Request (HARQ) Acknowledgement (ACK) information includes ACK or Non-Acknowledgment (NACK), when HARQ-ACK information includes only NACK, or when there is no feedback of HARQ-ACK information.

The following information is transmitted by means of the SCI format 2-A:
HARQ process number-4 bits.
New data indicator-1 bit.
Redundancy version-2 bits as defined in Table 7.3.1.1.1-2.
Source ID—8 bits as defined in clause 8.1 of [3GPP Technical Specification (TS) 38.214].
Destination ID—16 bits as defined in clause 8.1 of [TS 38.214].
HARQ feedback enabled/disabled indicator-1 bit as defined in clause 16.3 of [TS 38.213].
Cast type indicator-2 bits as defined in Table 1 and in clause 8.1 of [TS 38.214].
Channel state information (CSI) request-1 bit as defined in clause 8.2.1 of [TS 38.214] and in clause 8.1 of [TS 38.214].

TABLE 1
Cast type indicator

| Value of Cast type | |
|---|---|
| indicator | Cast type |
| 00 | Broadcast |
| 01 | Groupcast |
| | when HARQ-ACK information includes |
| | ACK or NACK |
| 10 | Unicast |
| 11 | Groupcast |
| | when HARQ-ACK information includes |
| | only NACK |

SCI format 2-B is used for the decoding of PSSCH, with HARQ operation when HARQ-ACK information includes only NACK, or when there is no feedback of HARQ-ACK information. The following information is transmitted by means of the SCI format 2-B:
HARQ process number—4 bits.
1 New data indicator—1 bit.
Redundancy version—2 bits as defined in Table 7.3.1.1.1-2.
Source ID—8 bits as defined in clause 8.1 of [TS 38.214].
Destination ID—16 bits as defined in clause 8.1 of [TS 38.214].
HARQ feedback enabled/disabled indicator-1 bit as defined in clause 16.3 of [TS 38.213].
Zone ID—12 bits as defined in clause 5.8.11 of [TS 38.331].
Communication range requirement—4 bits determined by higher layer parameter sl-ZoneConfigMCR-Index.

TABLE 2
Channel Access Priority Class (CAPC)

| Channel | | | | | |
|---|---|---|---|---|---|
| Access | | | | | |
| Priority | | | | | |
| Class (p) | mₚ | CW_{min, p} | CW_{max, p} | T_{m cot, p} | allowed CWₚsizes |
| 1 | 1 | 3 | 7 | 2 ms | {3, 7} |
| 2 | 1 | 7 | 15 | 3 ms | {7, 15} |
| 3 | 3 | 15 | 63 | 8 or 10 | {15, 31, 63} |
| | | | | ms | |
| 4 | 7 | 15 | 1023 | 8 or 10 | {15, 31, 63, 127, |
| | | | | ms | 255, 511, 1023} |

In implementations, a responding UE over a shared COT can be:
a receiving UE, which is the target of a PSCCH/PSSCH transmission of a COT initiator:
   In the case of unicast from the COT initiator, within the same COT when the source and destination IDs contained in the COT initiator's SCI match to the corresponding destination and source IDs relating to the same unicast at the receiving UE
   In the case of groupcast and broadcast, when the destination ID contained in the COT initiator's SCI match to a destination ID known at the receiving UE
a UE identified by ID(s), if additional IDs are supported in the COT sharing information (in addition to the source and destination IDs of the PSCCH/PSSCH transmission), when additional IDs are included in the COT sharing information from the COT initiator

Accordingly, solutions are provided in this disclosure for how L1 IDs can be implicitly provided by a COT initiator to select COT candidates. For instance, L1 IDs of COT candidates may not be transmitted explicitly in SCI, which can reduce the size of SCI and conserve device and network resources.

In the discussion herein the terms eNB and/or gNB is used for the base station but it is replaceable by any other radio access node, e.g. base station (BS), eNB, gNB, AP, NR, etc. Further the proposed techniques may be described in the context of 5G NR. However, the proposed techniques are applicable to other mobile communication systems supporting serving cells and/or carriers being configured for sidelink communication, such as over PC5 interface.

On implementations, COT sharing information containing ID(s) (e.g., L1 source ID and/or L1 destination ID) which may be provided by a COT initiator within a channel occupancy duration using the COT sharing indicator transmitted by the COT initiator and the COT initiator may implicitly provide additional IDs (e.g., L1 source IDs and/or L1 destination IDs) to enable the COT initiator SCI to match corresponding destination and source IDs relating to unicast, groupcast, and/or broadcast transmission at the receiver UE(s) that represent COT candidates.

The following definitions may be used in the present disclosure, such as for the purpose of sidelink channel access mechanisms:
Tx UE: A UE that transmits a COT sharing indicator via a sidelink connection
Rx UE: A UE that receives a COT sharing indicator via a sidelink connection
COT Initiator: A sidelink device that initiated a channel occupancy e.g., Tx UE
COT Donor: A sidelink device that transmits a COT sharing indicator, e.g. a Tx UE. The
COT Donor may be identical to the COT Initiator
COT Candidate: A sidelink device that receives a COT sharing indicator, e.g. a Rx UE

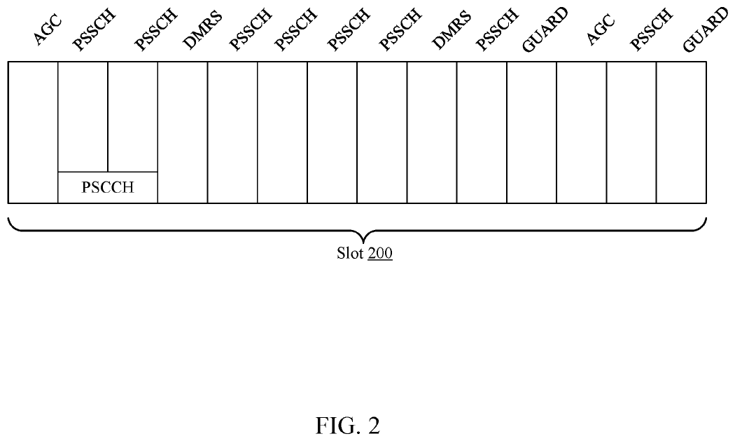

FIG. 2 illustrates an example of a sidelink slot 200 that supports COT sharing in accordance with aspects of the present disclosure. In this particular example the slot 200 includes 14 sidelink symbols allocated for different purposes including automatic gain control (AGC), PSSCH, PSCCH, demodulation reference signal (DMRS), guard symbols, and physical sidelink feedback channel (PSFCH). The sidelink slot 200 structure may include an AGC symbol at the beginning of the slot then PSCCH symbol followed by the PSSCH symbols and the last symbol in the slot is configured as a gap symbol (e.g., guard as shown in the slot 200) to enable switching time from Tx to Rx. First SCI can be transmitted using PSCCH and second SCI is can be transmitted within PSSCH.

In implementations L2 source ID and L2 destination ID can each be 24 bits provided by higher layer and transmitted in a MAC header. The physical layer, however, can transmit 16 bit L1 destination ID and 8 bit L1 source ID which are truncated portion of the L2 IDs. Second SCI can include 16 bit L1 destination ID and 8 bit L1 source ID and thus when the COT sharing indicator is transmitted, one L1 can be included explicitly as part of the second SCI. In implementations, one or more additional IDs can be provided using explicit or implicit techniques such as described herein.

In implementations COT candidates may be determined in cases of unicast from the COT initiator, such as within the same COT when the source and destination IDs contained in the COT initiator's SCI match the corresponding destination and source IDs relating to a same unicast at the receiving UE. In scenarios for groupcast and broadcast, COT candidates may be determined when the destination ID contained in the COT initiator SCI matches to a destination ID known at the receiving UE. Although L1 IDs are discussed herein, the described techniques are also applicable for L2 ID such as L2 source ID and L2 destination ID, such as that are each 24 bit.

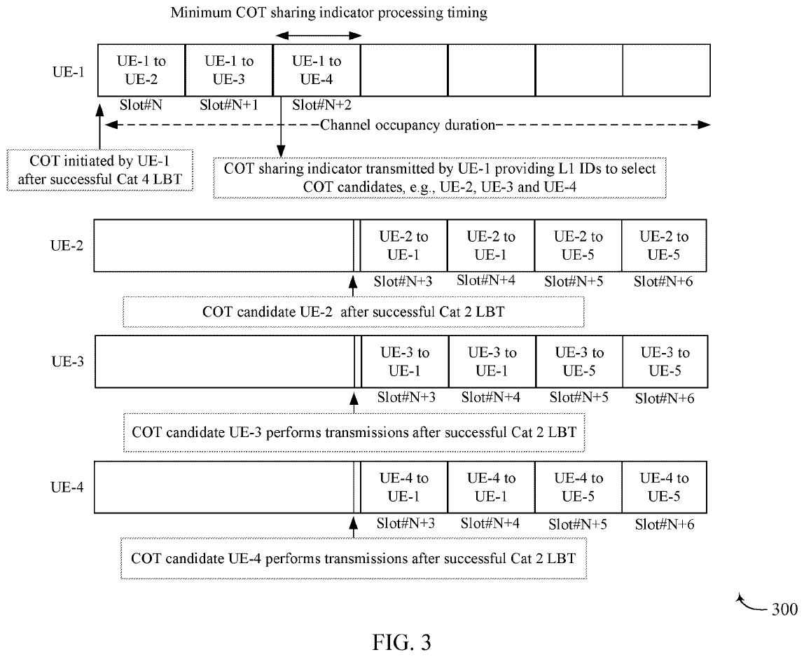

FIG. 3 illustrates a scenario 300 that supports COT sharing in accordance with aspects of the present disclosure. The scenario 300, for instance, represents implementations for UE to UE COT sharing. In implementations a COT initiator implicitly provides L1 IDs to select COT candidates. For instance, a Tx UE which is the COT initiator UE-1 after performing Cat 4 listen before talk (LBT) may share remaining COT with another UE(s) using a ‘COT sharing indicator’ as illustrated in the scenario 300, such as providing L1 IDs (e.g., L1 source IDs and L1 destination IDs) using a combination of explicit and implicit techniques to indicate one or more COT candidate(s). For instance, one L1 ID can be provided within the SCI transmitting the COT sharing indicator and additional IDs can be implicitly derived or provided using techniques described herein.

In implementations such COT candidates may use the shared COT for transmitting PSCCH/PSSCH/PSFCH/SSBs of any cast types and at least one transmission to the COT initiator in the remaining channel occupancy duration.

In implementations a UE can transmit both PSCCH and PSSCH in a slot and the SCI transmitted by the COT initiator in a slot may schedule PSSCH containing one L1 source ID and L1 destination IDs. When the SCI containing COT sharing indicator is transmitted in Slot N+2, L1 IDs (e.g., L1 source ID(s) and L1 destination ID(s)) selecting one or more COT candidates can be implicitly provided by the COT initiator UE, such as by means of PSCCH/PSSCH transmissions performed by the COT initiator UE in the previous slots (e.g., Slot N to Slot N+2) from the initiation of channel occupancy duration.

In implementations, L1 IDs in SCI transmitted by COT initiator UEs from the first slot of the channel occupancy until the slot where COT sharing indicator can be transmitted within the channel occupancy duration can be considered as candidate COT candidates associated with the shared COT initiated by UE-1. In this manner, L1 IDs of the COT candidates may not be transmitted explicitly in COT sharing indicator SCIs or medium access control (MAC) control element (CE), thus saving size of the SCI and MAC CE.

In the scenario 300, UE-1 initiates channel occupancy in slot #N and transmits to UE-2, UE-3 and UE-4, where UE-2, UE-3, UE-4 are indicated using distinct L1 source IDs and/or L1 destination IDs in their respective PSSCH slots. The L1 IDs transmitted by PSCCHs/PSSCHs from the slot #N until Slot N+2 where COT sharing indicator is transmitted can be considered for candidate COT candidates. Although in the scenario 300 COT candidates are indicated as UE-2, UE-3, UE-4 they can be referred to as L1 source ID #2/L1 destination ID #2 and L1 source ID #3/L1 destination ID #3, and so on, in their respective SCI.

In implementations, a COT candidate can perform transmission in the shared COT to any L1-IDs unless the COT candidate performs at least one transmission to a COT initiator within the shared remaining channel occupancy duration. In implementations to select at least one L1 ID from a plurality of IDs associated with the COT initiator in the form of source IDs and destination IDs, a COT candidate checks for past transmission with those L1 IDs of a COT initiator within the same COT such that the COT candidate makes at least one PSSCH/PSCCH transmission to one of those L1 IDs within the shared COT.

In implementations, the SCI transmitting a COT sharing indicator may include information to restrict the number of COT candidates. If there is no information on such a restriction, L1 IDs transmitted by COT initiating UE from the COT initiating PSSCH slot until the PSSCH slot of the COT sharing indicator may become one or more actual COT candidates implicitly.

In implementations information on the restriction may include limiting the L1 IDs of the candidate COT candidates to become actual COT candidates to:
certain cast types
range, e.g., minimum communication range-L1 IDs within the range may become actual COT candidates
relative number of slots-L1 IDs transmitted by PSCCHs/PSSCHs within the relative number of previous slots from the slot where COT sharing indicator is transmitted can become actual COT candidates
including previous COT-L1 IDs transmitted by PSCCHs/PSSCHs in the slots belonging to previous channel occupancy durations can become actual COT candidates

In implementations, Rx UEs receiving PSCCH/PSSCH transmission from a COT initiator in the channel occupancy duration may be provided with one of the following to determine one or more L1 IDs as candidate COT candidates:
Forward COT start indication or
Backward COT start indication or
Combination of Forward COT start indication and backward COT start indication

In implementations if a COT initiator shares the COT sharing indicator immediately after initiating the channel occupancy duration, then L1-IDs used by the COT initiator to perform PSCCH/PSSCH transmission within the channel occupancy may be candidate COT candidates. Further, L1-IDs from the slot where the COT sharing indicator is transmitted until the slot where the COT can be shared to the candidate. Alternatively or additionally, a field can be included in a COT sharing indicator for a number of K9 slots, and IDs being addressed within K9 slots of the COT sharing indicator can be implicitly candidate COT candidates.

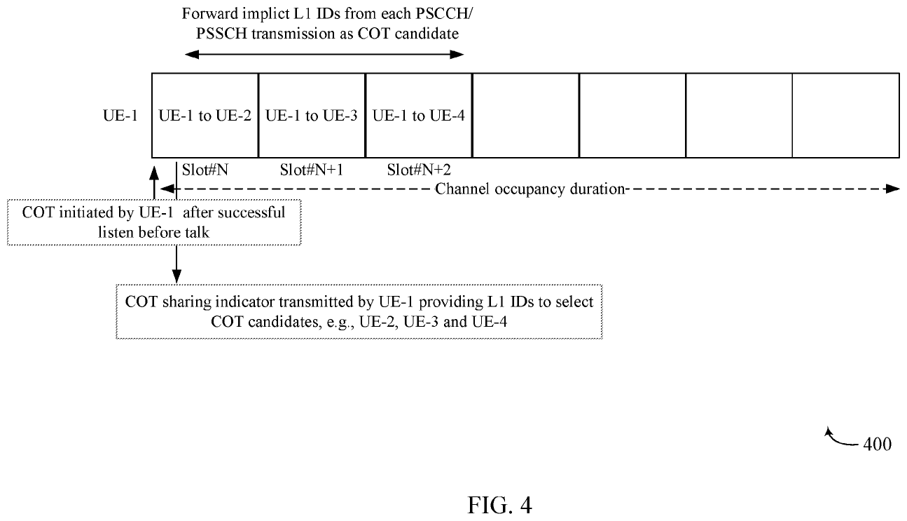

FIG. 4 illustrates a scenario 400 that supports COT sharing in accordance with aspects of the present disclosure. The scenario 400, for instance, represents implementations for forward indications for determining COT candidates.

In implementations a field can be included in a COT sharing indicator for a number of K9 slots, and IDs addressed within previous K9 slots of the COT sharing indicator are implicitly candidate COT candidates otherwise indicated IDs transmitted using the last COT are candidate COT candidates.

In implementations, a COT initiator can transmit candidate COT candidate indicator bit(s) in each of the PSCCH/PSSCH transmission according to their L1 IDs transmitted in each slots and when a COT sharing indicator is transmitted, those L1 IDs associated with the candidate COT candidate indicator bit(s) in the past transmission within the same COT can become actual COT candidates.

In implementations, a new field can be used to configure whether in a COT the implicit sharing such as described in above implementations is enabled in a COT, and optionally in addition to explicit ID transmission using second SCI or whether only explicit ID using second SCI is supported.

In implementations, if a UE initiates COT with more than one resource block set (RBset) (e.g., wideband), the COT initiator may contain an RBset index in the COT sharing indicator and another RBset which is not shared may be used by the COT initiator for its own PSCCH/PSSCH transmissions. In implementations, different UEs can implement different resource reservations in different resource block (RB) sets, hence a COT initiator may use multiple RB sets for PSSCH/PSCCH transmission for a time but then relinquish RBset due to existing reservations using the COT sharing principles.

Combinations of one or more above implementation may be implemented together to implicitly and/or explicitly provided L1 IDs of candidate COT candidates.

In implementations a COT candidate can perform transmission in a shared COT to other L1-IDs unless the COT candidate performs at least one transmission to a COT initiator within the shared remaining channel occupancy duration, and a combination of the techniques described herein may also implicitly and/or explicitly provide L1 IDs of the COT initiator.

In implementations a COT candidate may be determined in the case of unicast from the COT initiator within the same COT when the L1 source ID and L1 destination ID contained in the COT initiator's SCI and/or L2 ID in the MAC header match a corresponding L2 destination ID and L2 source ID and/or L1 destination ID and L1 source ID relating to the same unicast at the receiving UE.

In implementations involving groupcast and broadcast, a COT candidate may be determined when the L1 destination ID contained in the COT initiator SCI and/or L2 ID in MAC header match to a L2 destination ID and/or L1 destination ID known at the receiving UE.

In implementations one or more of the indications, restrictions, parameters, etc., described herein may be transmitted using SCI, MAC CE, or a combination of both. In implementations, a mapping list between source ID and destination ID to a logical ID may be created and transmitted using the higher layer signaling such as MAC CE and/or PC5 RRC and the index to the mapping list may be transmitted using SCI.

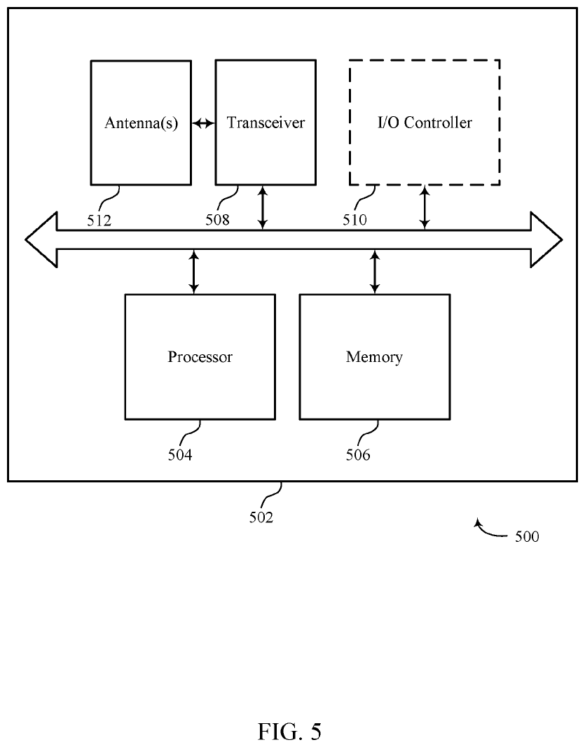

FIG. 5 illustrates an example of a block diagram 500 of a device 502 (e.g., an apparatus) that supports COT sharing in accordance with aspects of the present disclosure. The device 502 may be an example of UE 104 as described herein. The device 502 may support wireless communication with one or more network entities 102, UEs 104, or any combination thereof. The device 502 may include components for bi-directional communications including components for transmitting and receiving communications, such as a processor 504, a memory 506, a transceiver 508, and an I/O controller 510. These components may be in electronic communication or otherwise coupled (e.g., operatively, communicatively, functionally, electronically, electrically) via one or more interfaces (e.g., buses).

The processor 504, the memory 506, the transceiver 508, or various combinations thereof or various components thereof may be examples of means for performing various aspects of the present disclosure as described herein. For example, the processor 504, the memory 506, the transceiver 508, or various combinations or components thereof may support a method for performing one or more of the operations described herein.

In some implementations, the processor 504, the memory 506, the transceiver 508, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 504 and the memory 506 coupled with the processor 504 may be configured to perform one or more of the functions described herein (e.g., executing, by the processor 504, instructions stored in the memory 506). In the context of UE 104, for example, the transceiver 508 and the processor coupled 504 coupled to the transceiver 508 are configured to cause the UE 104 to perform the various described operations and/or combinations thereof.

For example, the processor 504 and/or the transceiver 508 may support wireless communication at the device 502 in accordance with examples as disclosed herein. For instance, the processor 504 and/or the transceiver 508 may be configured as and/or otherwise support a means to perform a listen before talk procedure in an unlicensed spectrum to initiate a channel occupancy duration; select one or more COT candidate user equipment (UE) using one or more Layer 1 (L1) identifiers (IDs) provided by a COT initiator using one or more of an explicit indication or an implicit indication; and transmit, based on the one or more of the explicit indication or the implicit indication, a UE-to-UE COT sharing indicator to one or more COT candidate UE for sharing a remaining channel occupancy duration.

Further, in some implementations, the listen before talk procedure includes a category 4 (Cat 4) listen before talk procedure; the processor is configured to cause the apparatus to select the one or more COT candidates implicitly and based on the one or more L1 IDs transmitted by the COT initiator from one or more of a first physical sidelink control channel (PSCCH) slot or a first physical sidelink shared channel (PSSCH) slot of the channel occupancy until one or more of a PSCCH slot or a PSSCH slot in which the COT sharing indicator is transmitted within the channel occupancy duration.

In a further example, the processor 504 and/or the transceiver 508 may support wireless communication at the device 502 in accordance with examples as disclosed herein. The processor 504 and/or the transceiver 508, for instance, may be configured as or otherwise support a means for performing a listen before talk procedure in an unlicensed spectrum to initiate a channel occupancy duration; selecting one or more COT candidate UE using one or more Layer 1 (L1) identifiers (IDs) provided by a COT initiator using one or more of an explicit indication or an implicit indication; and transmitting, based on the one or more of the explicit indication or the implicit indication, a UE-to-UE COT sharing indicator to one or more COT candidate UE for sharing a remaining channel occupancy duration.

Additionally, the device 502 (e.g., a UE 104) may be configured to support any one or combination of where the listen before talk procedure includes a category 4 (Cat 4) listen before talk procedure; selecting the one or more COT candidate UE implicitly and based on the one or more L1 IDs transmitted by the COT initiator; selecting the one or more COT candidate UE implicitly and based on the one or more L1 IDs transmitted by the COT initiator from one or more of a first physical sidelink control channel (PSCCH) slot or a first physical sidelink shared channel (PSSCH) slot of the channel occupancy until one or more of a PSCCH slot or a PSSCH slot in which the COT sharing indicator is transmitted within the channel occupancy duration; further including receiving an explicit indication of the one or more L1 IDs; the explicit indication includes sidelink control information (SCI).

Additionally, or alternatively, the device 502 may support at least one memory (e.g., the memory 506) and at least one processor (e.g., the processor 504) coupled with the at least one memory and configured to cause the UE to perform a listen before talk procedure in an unlicensed spectrum to initiate a channel occupancy duration; select one or more COT candidate UE using one or more Layer 1 (L1) identifiers (IDs) provided by a COT initiator using one or more of an explicit indication or an implicit indication; and transmit, based on the one or more of the explicit indication or the implicit indication, a UE-to-UE COT sharing indicator to one or more COT candidate UE for sharing a remaining channel occupancy duration.

Additionally, the device 502 may be configured to support any one or combination of where the listen before talk procedure includes a category 4 (Cat 4) listen before talk procedure; the at least one processor is configured to cause the UE to select the one or more COT candidate UE implicitly and based on the one or more L1 IDs transmitted by the COT initiator; the at least one processor is configured to cause the UE to select the one or more COT candidate UE implicitly and based on the one or more L1 IDs transmitted by the COT initiator from one or more of a first physical sidelink control channel (PSCCH) slot or a first physical sidelink shared channel (PSSCH) slot of the channel occupancy until one or more of a PSCCH slot or a PSSCH slot in which the COT sharing indicator is transmitted within the channel occupancy duration; the at least one processor is configured to cause the UE to receive an explicit indication of the one or more L1 IDs; the explicit indication includes sidelink control information (SCI); the SCI includes information restricting a number of the one or more COT candidate UE.

The processor 504 of the device 502, such as a UE 104, may support wireless communication in accordance with examples as disclosed herein. The processor 504 includes at least one controller coupled with at least one memory, and the at least one controller is configured to and/or operable to cause the processor to perform a listen before talk procedure in an unlicensed spectrum to initiate a channel occupancy duration; select one or more COT candidate user equipment (UE) using one or more Layer 1 (L1) identifiers (IDs) provided by a COT initiator using one or more of an explicit indication or an implicit indication; and transmit, based on the one or more of the explicit indication or the implicit indication, a UE-to-UE COT sharing indicator to one or more COT candidate UE for sharing a remaining channel occupancy duration. Further, the at least one controller may be configured to and/or operable to cause the processor to perform any one or more of the operations described herein, such as with reference to a UE 104 and/or the device 502.

The processor 504 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 504 may be configured to operate a memory array using a memory controller. In some other implementations, a memory controller may be integrated into the processor 504. The processor 504 may be configured to execute computer-readable instructions stored in a memory (e.g., the memory 506) to cause the device 502 to perform various functions of the present disclosure.

The memory 506 may include random access memory (RAM) and read-only memory (ROM). The memory 506 may store computer-readable, computer-executable code including instructions that, when executed by the processor 504 cause the device 502 to perform various functions described herein. The code may be stored in a non-transitory computer-readable medium such as system memory or another type of memory. In some implementations, the code may not be directly executable by the processor 504 but may cause a computer (e.g., when compiled and executed) to perform functions described herein. In some implementations, the memory 506 may include, among other things, a basic I/O system (BIOS) which may control basic hardware or software operation such as the interaction with peripheral components or devices.

The I/O controller 510 may manage input and output signals for the device 502. The I/O controller 510 may also manage peripherals not integrated into the device M02. In some implementations, the I/O controller 510 may represent a physical connection or port to an external peripheral. In some implementations, the I/O controller 510 may utilize an operating system such as iOS®, ANDROID®, MS-DOS®, MS-WINDOWS®, OS/2®, UNIX®, LINUX®, or another known operating system. In some implementations, the I/O controller 510 may be implemented as part of a processor, such as the processor M08. In some implementations, a user may interact with the device 502 via the I/O controller 510 or via hardware components controlled by the I/O controller 510.

In some implementations, the device 502 may include a single antenna 512. However, in some other implementations, the device 502 may have more than one antenna 512 (e.g., multiple antennas), including multiple antenna panels or antenna arrays, which may be capable of concurrently transmitting or receiving multiple wireless transmissions. The transceiver 508 may communicate bi-directionally, via the one or more antennas 512, wired, or wireless links as described herein. For example, the transceiver 508 may represent a wireless transceiver and may communicate bi-directionally with another wireless transceiver. The transceiver 508 may also include a modem to modulate the packets, to provide the modulated packets to one or more antennas 512 for transmission, and to demodulate packets received from the one or more antennas 512.

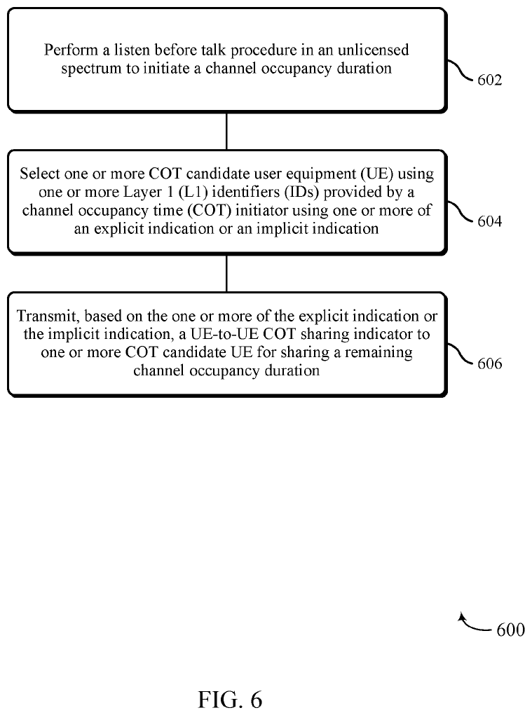

FIG. 6 illustrates a flowchart of a method 600 that supports COT sharing in accordance with aspects of the present disclosure. The operations of the method 600 may be implemented by a device or its components as described herein. For example, the operations of the method 600 may be performed by a UE 104 as described with reference to FIGS. 1 through 5. In some implementations, the device may execute a set of instructions to control the function elements of the device to perform the described functions. Additionally, or alternatively, the device may perform aspects of the described functions using special-purpose hardware.

At 602, the method may include performing a listen before talk procedure in an unlicensed spectrum to initiate a channel occupancy duration. The operations of 602 may be performed in accordance with examples as described herein. In some implementations, aspects of the operations of 602 may be performed by a device as described with reference to FIG. 1.

At 604, the method may include selecting one or more COT candidate user equipment (UE) using one or more Layer 1 (L1) identifiers (IDs) provided by a COT initiator using one or more of an explicit indication or an implicit indication. The operations of 604 may be performed in accordance with examples as described herein. In some implementations, aspects of the operations of 604 may be performed by a device as described with reference to FIG. 1.

At 606, the method may include transmitting, based on the one or more of the explicit indication or the implicit indication, a UE-to-UE COT sharing indicator to one or more COT candidate UE for sharing a remaining channel occupancy duration. The operations of 606 may be performed in accordance with examples as described herein. In some implementations, aspects of the operations of 606 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

Implementations described herein may include:

In some aspects, the techniques described herein relate to an apparatus including: a transceiver; and a processor coupled to the transceiver, the processor and the transceiver configured to cause the apparatus to: perform a listen before talk procedure in an unlicensed spectrum to initiate a channel occupancy duration; select one or more COT candidate user equipment (UE) using one or more Layer 1 (L1) identifiers (IDs) provided by a COT initiator using one or more of an explicit indication or an implicit indication; and transmit, based on the one or more of the explicit indication or the implicit indication, a UE-to-UE COT sharing indicator to one or more COT candidate UE for sharing a remaining channel occupancy duration.

In some aspects, the techniques described herein relate to an apparatus, wherein the listen before talk procedure includes a category 4 (Cat 4) listen before talk procedure.

In some aspects, the techniques described herein relate to an apparatus, wherein the processor is configured to cause the apparatus to select the one or more COT candidates implicitly and based on the one or more L1 IDs transmitted by the COT initiator from one or more of a first physical sidelink control channel (PSCCH) slot or a first physical sidelink shared channel (PSSCH) slot of the channel occupancy until one or more of a PSCCH slot or a PSSCH slot in which the COT sharing indicator is transmitted within the channel occupancy duration.

In some aspects, the techniques described herein relate to a method including: performing a listen before talk procedure in an unlicensed spectrum to initiate a channel occupancy duration; selecting one or more COT candidate user equipment (UE) using one or more Layer 1 (L1) identifiers (IDs) provided by a COT initiator using one or more of an explicit indication or an implicit indication; and transmitting, based on the one or more of the explicit indication or the implicit indication, a UE-to-UE COT sharing indicator to one or more COT candidate UE for sharing a remaining channel occupancy duration.

In some aspects, the techniques described herein relate to a method, wherein the listen before talk procedure includes a category 4 (Cat 4) listen before talk procedure.

In some aspects, the techniques described herein relate to a method, including selecting the one or more COT candidates implicitly and based on the one or more L1 IDs transmitted by the COT initiator from one or more of a first physical sidelink control channel (PSCCH) slot or a first physical sidelink shared channel (PSSCH) slot of the channel occupancy until one or more of a PSCCH slot or a PSSCH slot in which the COT sharing indicator is transmitted within the channel occupancy duration.

What is claimed is:

1. A user equipment (UE) for wireless communication, comprising:
at least one memory; and
at least one processor coupled with the at least one memory and operable to cause the UE to:
perform a listen before talk procedure in an unlicensed spectrum to initiate a channel occupancy duration;
select one or more channel occupancy time (COT) candidate UE using one or more Layer 1 (L1) identifiers (IDs) provided by a COT initiator using one or more of an explicit indication or an implicit indication; and
transmit, based on the one or more of the explicit indication or the implicit indication, a UE-to-UE COT sharing indicator to one or more COT candidate UE for sharing a remaining channel occupancy duration.

2. The UE of claim 1, wherein the listen before talk procedure comprises a category 4 (Cat 4) listen before talk procedure.

3. The UE of claim 1, wherein the at least one processor is operable to cause the UE to select the one or more COT candidate UE implicitly and based on the one or more L1 IDs transmitted by the COT initiator.

4. The UE of claim 1, wherein the at least one processor is operable to cause the UE to select the one or more COT candidate UE implicitly and based on the one or more L1 IDs transmitted by the COT initiator from one or more of a first physical sidelink control channel (PSCCH) slot or a first physical sidelink shared channel (PSSCH) slot of the channel occupancy until one or more of a PSCCH slot or a PSSCH slot in which the COT sharing indicator is transmitted within the channel occupancy duration.

5. The UE of claim 1, wherein the at least one processor is operable to cause the UE to receive an explicit indication of the one or more L1 IDs.

6. The UE of claim 5, wherein the explicit indication comprises sidelink control information (SCI).

7. The UE of claim 6, wherein the SCI comprises information restricting a number of the one or more COT candidate UE.

8. A processor for wireless communication, comprising:
at least one controller coupled with at least one memory and operable to cause the processor to:
perform a listen before talk procedure in an unlicensed spectrum to initiate a channel occupancy duration;
select one or more channel occupancy time (COT) candidate user equipment (UE) using one or more Layer 1 (L1) identifiers (IDs) provided by a COT initiator using one or more of an explicit indication or an implicit indication; and
transmit, based on the one or more of the explicit indication or the implicit indication, a UE-to-UE COT sharing indicator to one or more COT candidate UE for sharing a remaining channel occupancy duration.

9. The processor of claim 8, wherein the listen before talk procedure comprises a category 4 (Cat 4) listen before talk procedure.

10. The processor of claim 8, wherein the at least one controller is operable to cause the processor to select the one or more COT candidate UE implicitly and based on the one or more L1 IDs transmitted by the COT initiator.

11. The processor of claim 8, wherein the at least one controller is operable to cause the processor to select the one or more COT candidate UE implicitly and based on the one or more L1 IDs transmitted by the COT initiator from one or more of a first physical sidelink control channel (PSCCH) slot or a first physical sidelink shared channel (PSSCH) slot of the channel occupancy until one or more of a PSCCH slot or a PSSCH slot in which the COT sharing indicator is transmitted within the channel occupancy duration.

12. The processor of claim 8, wherein the at least one controller is operable to cause the processor to receive an explicit indication of the one or more L1 IDs.

13. The processor of claim 12, wherein the explicit indication comprises sidelink control information (SCI).

14. The processor of claim 13, wherein the SCI comprises information restricting a number of the one or more COT candidate UE.

15. A method performed by a user equipment (UE), the method comprising:
performing a listen before talk procedure in an unlicensed spectrum to initiate a channel occupancy duration;
selecting one or more channel occupancy time (COT) candidate UE using one or more Layer 1 (L1) identifiers (IDs) provided by a COT initiator using one or more of an explicit indication or an implicit indication; and
transmitting, based on the one or more of the explicit indication or the implicit indication, a UE-to-UE COT sharing indicator to one or more COT candidate UE for sharing a remaining channel occupancy duration.

16. The method of claim 15, wherein the listen before talk procedure comprises a category 4 (Cat 4) listen before talk procedure.

17. The method of claim 15, further comprising selecting the one or more COT candidate UE implicitly and based on the one or more L1 IDs transmitted by the COT initiator.

18. The method of claim 15, further comprising selecting the one or more COT candidate UE implicitly and based on the one or more L1 IDs transmitted by the COT initiator from one or more of a first physical sidelink control channel (PSCCH) slot or a first physical sidelink shared channel (PSSCH) slot of the channel occupancy until one or more of a PSCCH slot or a PSSCH slot in which the COT sharing indicator is transmitted within the channel occupancy duration.

19. The method of claim 15, wherein further comprising receiving an explicit indication of the one or more L1 IDs.

20. The method of claim 19, wherein the explicit indication comprises sidelink control information (SCI).
